(19) United States
(12) Patent Application Publication
(10) Pub. No.: US 2008/0087820 A1
(43) Pub. Date: Apr. 17, 2008

(54) PROBE CONTROL METHOD FOR SCANNING PROBE MICROSCOPE

(76) Inventors: Toru KURENUMA, Tsuchiura-Shi (JP); Hiroaki Yanagimoto, Tsuchiura-Shi (JP); Yukio Kembo, Tokyo (JP); Yuichi Kunitomo, Tsuchiura-Shi (JP); Takafumi Morimoto, Kashiwa-shi (JP); Satoshi Sekino, Ushiku-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/867,476

(22) Filed: Oct. 4, 2007

(30) Foreign Application Priority Data
May 10, 2006 (JP) 2006-273929

(51) Int. Cl. G01N 23/00

(52) U.S. Cl. 250/307

(57) ABSTRACT

This probe control method is applied to the scanning probe microscope having a probe section with a probe pointed at a sample, a detection section for detecting physical quantity between the sample and the probe, a measurement section for measuring the surface of the sample to obtain the surface information on the basis of the physical quantity when scanning the sample surface by the probe, and a movement mechanism with at least two degree of freedom. The probe control method has steps of moving the probe in a scanning direction different from the contact direction while making the probe come into contact with the sample surface, detecting the torsional state of the probe during the movement of the probe, and adjusting either or both of the rate in the scanning direction and the force in the contact direction on the basis of the detected value obtained by the detection step.

### BACKGROUND OF THE INVENTION

1. Field of the Invention

The present invention relates to a probe control method for a scanning probe microscope, more particularly relates to a probe control method for a scanning probe microscope, that is suitable for measuring a sample surface with uneven shapes when carrying out a scanning movement of the probe along the sample surface.

2. Description of the Related Art

Scanning probe microscopes are known as measurement systems having measurement resolutions enabling observation of fine objects on the atomic level or size. In recent years, scanning probe microscopes have been applied to a variety of fields such as measurement of the fine profile or uneven shapes in the surfaces of wafers or substrates on which semiconductor devices are fabricated. There are various types of scanning probe microscopes for the different physical quantities for detection used for measurement. For example, there are scanning tunnel microscopes utilizing tunnel current (STM), atomic force microscopes utilizing atomic force (AFM), magnetic microscopes utilizing magnetic force (MFM), etc. The ranges of their applications have been growing as well.

Atomic force microscopes are particularly suitable for detecting the fine profile or uneven shapes on sample surfaces and are proving their worth in the fields of semiconductor substrates, disks, etc. Recently, they have also been used in applications for in-line automatic inspection processes.

An atomic force microscope is basically configured to be have a measurement unit operating based on the principle of atomic force microscopes. The measurement unit is provided with a tripod-type or tube-type XYZ fine actuator formed utilizing piezoelectric devices. The bottom end of the XYZ fine actuator has a cantilever with a probe at its tip. The tip of the probe is directed to the surface of the sample. The cantilever is provided with, for example, an optical lever type photo detector. In the optical lever type photo detector, a laser beam emitted from a laser light source (laser oscillator) arranged above the cantilever is reflected at the back surface of the cantilever and detected by the photo detector. If the cantilever twists or bends, the spot of the incident laser beam at the photo detector (four-divided light receiving surface, for example) changes.

Therefore, if the probe and cantilever displace, it is possible to detect the direction and amount of the displacement based on a detection signal output from the photo detector. An atomic force microscope is usually further provided with a comparator and controller as a control system. The comparator compares the detection voltage signal output from the photo detector and the reference voltage and outputs an error signal. The controller generates a control signal resulting in an error signal of zero and sends this control signal to the Z-fine actuator in the XYZ fine actuator. A feedback servo control system holding the distance between the sample and probe constant is formed in this way. It is possible to use this configuration to make the probe track and scan the fine uneven shapes on the sample surface and measure their shapes.

When the atomic force microscopes were first invented, the central issue was the use of their high resolution for measurement of fine shapes on the surface of dimensions on the nanometer (nm) order. At the present time, however, scanning probe microscopes have expanded in range of use to include in-line automatic inspection in the middle of in-line fabrication systems of semiconductor devices. In view of this, in actual inspection processes, it is required to measure the extremely sharp uneven shapes in the fine uneven shapes on the surfaces of the semiconductor devices fabricated on wafers.

As technology for measuring the uneven surfaces, there is a scanning probe microscopes described in Japanese Patent Publication (A) No. 2002-14024. In this scanning probe microscope, when scanning the sample surface by the probe, it is controlled so that the relative velocity in a direction of the sample surface of the probe becomes fixed to the uneven surface of the sample. This control compensates for the shortage of the follow-up performance of the probe in the slope of the projected portions or the like on the sample surface.

The control system under the scanning probe microscope disclosed in Japanese Patent Publication (A) No. 2002-14024 has controlled to move the probe so that the linear velocity of the probe in the direction along the inclined surface becomes fixed, paying attention to the shortage of the follow-up performance of the probe to the sample. However, a reaction force due to the sample given to the tip of the probe from the sample surface changes according to the shape of the sample and the movement directions of the probe. For this reason, the reaction force has made various twisted states in the probe in accordance with the slope of the irregularity on the sample surface, and has been the cause for producing an error to measurement data.

Also, big torsion given to the probe caused serious damage to the probe, and has become the cause which shortens the life of the probe. Furthermore, for this reason, the wear amount of the probe is increased, and as a result the area that the same probe can measure is decreased. Thereby, there have arisen the problems that an accurate measurement value cannot be obtained in a large area, and that running cost is increased.

### SUMMARY OF THE INVENTION

An object of the present invention is to provide a probe control method for a scanning probe microscope, that can reduce an error of the measurement data by controlling torsional states of the probe appropriately, which are generated due to the reaction force given to the tip of the probe from the sloping sections in the uneven surface of the sample.

A probe control method for a scanning probe microscope according to the present invention is configured as follows to achieve the above object.

A probe control method for a scanning probe microscope is applied to the scanning probe microscope provided with a probe section with a probe arranged so as to be pointed at a sample, a detection section for detecting physical quantity between the sample and the probe, a measurement section for measuring the surface of the sample to obtain the surface information on the basis of the physical quantity when scanning the sample surface with the probe, and a movement mechanism with at least two degree of freedom. In the scanning probe microscope, the measurement section measures the surface of the sample while the movement mechanism changes the relative positional relationship between the probe and the sample by causing the probe scan the sample surface. The probe control method has steps of moving the probe in a scanning (or movement) direction different from the contact direction while making the probe come into contact with the sample surface, detecting the torsional state of the probe during the movement of the probe, and adjusting either or both of the rate (or speed) in the scanning direction and the force in the contact direction as to the probe on the basis of the detected value obtained by the detection step.

In accordance with the probe control method, in case that the probe (or the cantilever) is twisted by the reaction force impressed to the tip of the probe due to the slope section of the uneven surface of the sample when performing the measurement by making the probe scan the sample surface, either or both of the rate in the scanning direction and the force in the contact direction as to the probe is adjusted to cancel the torsinal state concerning the probe, and thus the error of the measurement data can be reduced.

Moreover, in the probe control method for the scanning probe microscope, preferably, the adjustment of the rate in the scanning direction of the probe is performed so that the torsional amount in the torsional state of the probe may be canceled.

In the probe control method for the scanning probe microscope, preferably, the scanning direction is a probe scanning direction along the surface of the sample.

In the probe control method for the scanning probe microscope, preferably, a cantilever with the probe has notches which are easy to produce the torsion.

According to the present invention, in the probe movement control of the scanning probe microscope in which the probe is moved to follow the uneven shapes at measuring points on the sample surface, since the torsional state of the probe is detected during the following movement along the sample surface and further the rate in the scanning direction and/or the force in the contact direction as to the probe on the basis of the detected value, an error of the measurement data due to the torsional state of the probe can be reduced and the reliability of measurement precision can be raised, and the life of the probe can be prolonged further and thus running cost can be lowered.

### BRIEF DESCRIPTION OF THE DRAWINGS

Objects and features of the present invention will become clearer from the following description of the preferred embodiments given with reference to the attached drawings, wherein:

FIG. 1 is a view of the overall configuration of a measurement section and control section of a scanning probe microscope to which a probe control method of the present invention is applied;

FIG. 2 is a view of illustrating a relationship among a cantilever, a probe and an optical lever type optical detection device in the scanning probe microscope;

FIG. 3 is a view of illustrating an example of the scanning/measuring movement of the probe in the probe control method of the embodiment according to the present invention;

FIG. 4 is a block diagram showing a control block for performing a control on a probe scanning direction in the embodiment of the probe control method;

FIG. 5 is a block diagram showing a control block for performing a control on a probe contact direction in the embodiment of the probe control method;

FIG. 6 is a block diagram showing a system for outputting a positional reference value; and

FIG. 7 is a perspective view showing another modified example of the cantilever.

### DESCRIPTION OF THE PREFERRED EMBODIMENTS

Preferred embodiments of the present invention will be described in detail below while referring to the attached figures.

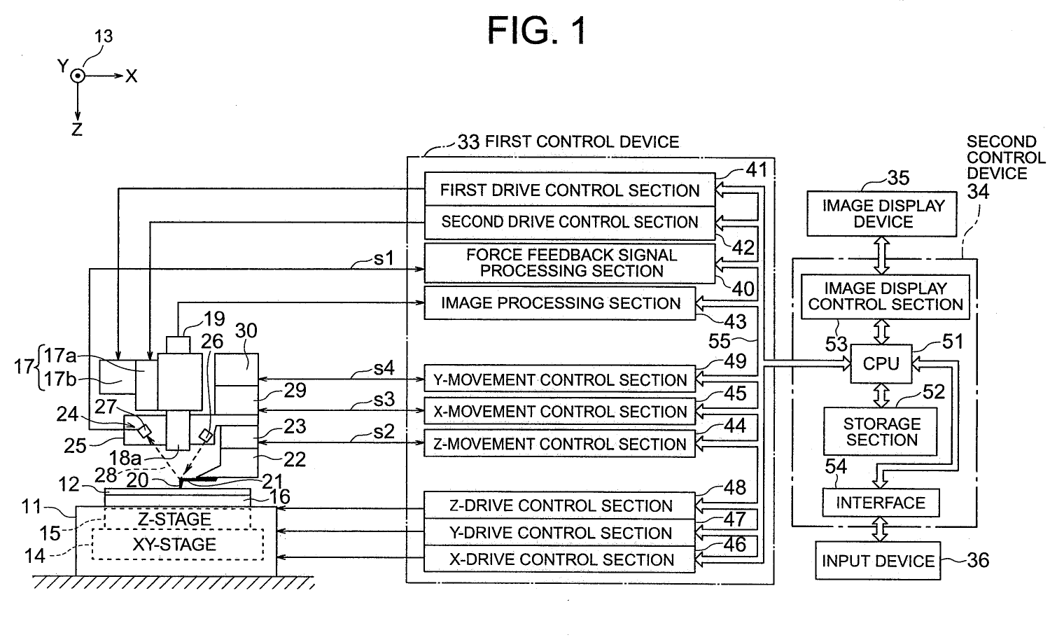

The overall configuration of a scanning probe microscope (SPM) to which a probe control method according to the present invention is applied will be explained with reference to FIG. 1. The scanning probe microscope is an atomic force microscope (AFM) as a typical example. However, the scanning probe microscope of the present invention does not limited to the atomic force microscope.

The lower part of the scanning probe microscope is provided with a sample stage 11. The sample stage 11 has a sample 12 placed on it. The sample stage 11 is a mechanism for changing the position of the sample 12 in a three-dimensional coordinate system 13 comprised of perpendicular X-, Y-, and Z-axes. The sample stage 11 is comprised of an XY-stage 14, a Z-stage 15 and a sample holder 16. The sample stage 11 usually is comprised as a coarse or rough actuator causing displacement (positional change) at the sample side.

The sample 12 with a relatively large area and thin shape is placed and holed on the top surface of the sample holder 16 of the sample stage 121. The sample 12 is, for example, a substrate or wafer on the surface of which integrated circuit patterns of semiconductor devices are fabricated. The sample 12 is fixed on the sample holder 16. The sample holder 16 is provided with a chuck mechanism for fixing the sample.

In the sample stage 11, concretely, the XY-stage 14 is a mechanism for making the sample 12 move on a horizontal plane (XY plane), while the Z-stage 15 is a mechanism for making the sample 12 move in the vertical direction (height direction). The Z-stage 15 is mounted on the XY-stage 14. A movable distance by the sample stage 11 is hundreds of mm (millimeter) in the X or Y direction and dozens of mm (millimeter) in the Z direction.

In FIG. 1, there are an optical microscope 18 provided with a drive mechanism 17 at a position above the sample 12. The optical microscope 18 is supported by a drive mechanism 17. The drive mechanism 17 is comprised of a focus-use Z-direction actuator 17a for moving the optical microscope 18 in the Z-axis direction and an XY direction actuator 17b for moving it in the XY axis directions. For mounting, the Z-direction actuator 17a moves the optical microscope 18 in the Z-axis direction, while the XY direction actuator 17b moves the unit of the optical microscope 18 and the Z-direction actuator 17a in the XY axis directions. The XY direction actuator 17b is fixed to a frame member, but in FIG. 1, illustration of the frame member is omitted. The optical microscope 18 is arranged with its object lens 18a directing the bottom and is arranged at a position approaching the surface of the sample 12 from directly above. The top end of the optical microscope 18 is additionally provided with a TV camera (imaging unit) 19. The TV camera 19 picks up an image of a specific region of the sample surface captured by the object lens 18a and outputs the image data.

A cantilever 21 provided with a probe 20 at its tip is arranged in a state approaching the upper side of the sample 12. The cantilever 21 is attached to a mount 22. The mount 22 is, for example, provided with an air suction section (not shown). The air suction part is connected to an air suction device (not shown). The cantilever 21 is fixed and attached by its large area base being attached by suction at the air suction part of the mount 22.

The above mount 22 is attached to a Z-fine actuator 23 for causing fine movement operation in the Z-direction. Further, the Z-fine actuator 23 is attached to the bottom surface of a supporting frame 25 described below for a cantilever displacement detector 24.

The cantilever displacement detector 24 is comprised of a support frame 25 to which a laser light source 26 and photo detector 27 are attached in a predetermined relative arrangement. The cantilever displacement detector 24 and the cantilever 21 are held in a constant positional relationship. A laser beam 28 emitted from the laser light source 26 is reflected at the back surface of the cantilever 21 and enters the photo detector 27. The cantilever displacement detector forms an optical lever-type photo detector. If the cantilever 21 twists, bends, or is otherwise deformed, this optical lever-type photo detector can detect the displacement due to the deformation.

The cantilever displacement detector 24 is attached to an XY fine actuator. The XY fine actuator has an X-fine actuator 29 and a Y-fine actuator 30. The XY fine actuator makes the cantilever 21 and the probe 20 etc. move in the directions of the X-axis and Y-axis by fine distances. At this time, the cantilever displacement detector 24 is simultaneously moved. The optical position-relationship between the cantilever 21 and the cantilever displacement detector 24 does not change by canceling the displacement in the Z-axis direction using optical mirrors which are not shown in the figure.

In the above explanation, the Z-fine actuator 23, the X-fine actuator 29 and Y-fine actuator 30 usually are comprised of piezoelectric devices. The Z-fine actuator 23, X-fine actuator 29 and Y-fine actuator 30 cause the probe 20 to displace by fine distances (for example, several angstroms (Å) to 10 μm, and maximum 100 μm) in the X-axis direction, Y-axis direction and Z-axis direction. Especially, the fine distance of the probe generated in the Z-axis direction as the displacement is dozens of μm. Further, the above Y-fine actuator 30 is attached to a frame mechanism which is not shown in the figure.

In the above mounting, the observation field of the optical microscope 18 includes the surface of a specific region of the sample 12 and the tip (back surface) of the cantilever 21 including the probe 20.

Next, a control system of the scanning probe microscope will be explained. The control system is comprised of a first control device 33 and a second control device 34. The controlling means for realizing in principle a measurement mechanism in the atomic force microscope (AFM) is constructed by programs (software) prepared in the first control device 33 as a computer. Also, the first control device 33 is for controlling the drive of a plurality of drive mechanisms. Further, the second control device 34 is positioned as a superior control device.

A control means for realizing in principal the measurement section based on the atomic force microscope is constructed as follows. In force feedback signal processing section 40 and the like, a voltage signal (s1) output from the photo detector 27 is inputted and compared with a reference voltage set in advance to output a deviation signal s1. A deviation controller within the force feedback signal processing section produces a control signal (s2, etc.) resulting in the deviation signal of zero and sends this control signal s2 to the Z-fine actuator 23, etc. The Z-fine actuator 23 receiving the control signal s2 adjusts the height position of the cantilever 21 to hold the distance between the probe 20 and the surface of the sample 12 constant. The control loop from the photo detector 27 to the Z-fine actuator 23 is, for example, a feedback servo control loop for detecting the state of deformation of the cantilever 21 by the optical lever-type photo detector and holding the distance between the probe 20 and the sample 12 at a predetermined constant distance determined based on the above reference voltage. Due to this control loop, the probe 20 is held at a constant distance from the surface of the sample 12 in the Z-axis direction, for example. If the probe 20 scans the surface of the sample 12 in this state, it is possible to measure profile or uneven shapes of the sample surface.

As to the X-fine actuator 29 and Y-fine actuator 30, respectively, a general feedback servo-control loop is formed by using a feedback signal outputted from a displacement unit. In FIG. 1, a signal s3 is an X feedback signal while it is also an X scanning command signal. Furthermore, a signal s4 is a Y feedback signal while it is also a Y scanning command signal.

Next, the first control device 33 is a control device for driving the parts of the scanning probe microscope and is provided with the following functional sections.

The optical microscope 18 can be changed in position by the drive mechanism 17 comprised of the focus-use Z-direction actuator 17a and XY direction actuator 17b. The first control device 33 is provided with a first drive control section 41 and second drive control section 42 for controlling the operations of the Z-direction actuator 17a and XY direction actuator 17b.

The image of the sample surface and cantilever 21 obtained by the optical microscope 18 is picked up by the TV camera 19 and fetched as image data. The image data obtained by the TV camera 19 of the optical microscope 18 is input to the first control device 33 and processed by an internal image processing section 43.

As to Z-fine actuator 23, in principle, the control signal s2 obtained through the feedback servo-control loop means the height signal of the probe 20 at the scanning probe microscope (atomic force microscope). The height signal of the probe 20, that is, the control signal s2, can give information relating to the change of the height position of the probe 20. The control signal s2 is given to the Z-fine actuator 23 from a Z-movement control section 44 of the control device 33.

The probe 20 is made to scan the sample surface at the measurement region of the surface of the sample 12 by driving the X-fine actuator 29 and Y-fine actuator 30. The drive of the X-fine actuator 29 is controlled by an X-movement control section 45 providing the X-fine actuator 29 with the X scan command signal and receiving the X feedback signal (S3). The drive of the Y-fine actuator 30 is controlled by a Y-movement control section 49 providing the Y-fine actuator 30 with the Y scan command signal and receiving the Y feedback signal (s4).

Further, the XY-stage 14 and the Z-stage 15 of the sample stage 11 are controlled by an X-drive control section 46 outputting an X-direction drive signal, a Y-drive control section 47 outputting the Y-direction drive signal, and a Z-drive control section 48 outputting a Z-direction drive signal.

Note that the first control device 33 is provided with a storage section (not shown) for storing setting control data, input optical microscope image data, data relating to the height position of the probe, etc. in accordance with need.

The second control device 34 is positioned as the superior one for the first control device 33. The second control device 34 performs processing such as storing and executing a usual measurement program, setting and storing usual measurement conditions, storing and executing an automatic measurement program, setting and storing its measurement conditions, storing the measurement data, performing image processing on the measurement results, and displaying the image at a display device (monitor) 35.

In particular, in case of the present invention, in the automatic measurement operation, the second control device carries out a measurement process for measuring sections of the sample surface with the slope of the uneven surface by changing the movement and posture of the probe in its movement or scanning direction. The second control device is provided with a program for performing the measurement while moving the probe in the upward direction along the slope by automatically changing the position, posture, etc. of the probe in the scanning direction.

In setting the measurement conditions, basic items such as the measurement range and measurement speed, the setting up for the scanning direction of the probe, the measurement conditions, and other conditions for automatic measurement are set. These conditions are stored and managed in a setting file. Further, it is also possible to configure the microscope to have a communication function for communicating with external devices.

The second control device 34 must have the above functions, so is comprised of a processing device constituted by a CPU 51 and a storage section 52. The storage section 52 stores the above programs and condition data etc. Further, the second control device 34 is provided with an image display control section 53, communicating section, etc. In addition, the second control device 34 is connected with an input device 36 through an interface 54. The input device 36 can be used to set and change the measurement program, measurement conditions, data, etc. stored in the storage section 52.

The CPU 51 of the second control device 34 provides superior or higher control instructions etc. to the functional parts of the first control device 33 through a bus 55 and is provided with image data or data relating to the height position of the probe from the image processing section 43, data processing section 44, etc.

Next, the basic operation of the above scanning probe microscope (atomic force microscope) will be explained.

The tip of the probe 20 of the cantilever 21 is made to approach a predetermined region of the surface of the semiconductor substrate or other sample 12 placed on the sample stage 11. Normally, the probe approach mechanism constituted by the Z-stage 15 is used to bring the probe 20 close to the surface of the sample 12 and atomic force is made to act to cause the cantilever 21 to bend. The bending amount due to the bending deformation of the cantilever 21 is detected by the above-mentioned optical lever-type photo detector. In this state, the probe 20 is made to move with respect to the sample surface so as to scan the sample surface (XY scan). The XY scan of the surface of the sample 12 by the probe 20 is performed by making the probe 20 move by the X-fine actuator 29 and Y-fine actuator 30 (fine movement) or by making the sample 12 move by the XY-stage 14 (coarse movement) so as to create relative movement in the XY plane between the sample 12 and the probe 20.

The probe 20 is moved by giving the X scan signal s3 relating to X-fine movement to the X-fine actuator 29 provided with the cantilever 21 and giving the Y scan signal s4 relating to Y-fine movement to the Y-fine actuator 30. The scan signal s3 relating to the X-fine movement is given from the X-movement control section 45 in the first control device 33 and the scan signal s4 relating to the Y-fine movement is given from the Y-movement control section 49 in the first control device 33. On the other hand, the sample is moved by giving drive signals from the X-drive control section 46 and the Y-drive control section 47 to the XY-stage 14 of the sample stage 11.

The X-fine actuator 29 or Y-fine actuator 30 is comprised of a piezoelectric device and enables high precision and high resolution scan movement. Further, the measurement range measured by the XY scan by the X-fine actuator 29 and Y-fine actuator 30 is limited by the stroke of the piezoelectric device, so becomes a range determined by a distance of about 100 μm even at the maximum. According to the XY scan by the X-fine actuators 29 and Y-fine actuator 30, measurement in a fine, narrow range becomes possible. On the other hand, the XY-stage 14 is comprised of an electromagnetic motor as a drive, so the stroke can be enlarged up to several hundred mm. According to the XY scan by the XY-stage, measurement in a broad range becomes possible.

In this way, a predetermined measurement region on the surface of the sample 12 is scanned by the probe 20 and the amount of bending (amount of deformation by bending etc.) of the cantilever 21 is controlled to become constant by the feedback servo control loop. The amount of bending of the cantilever 21 is constantly controlled to match a reference amount of bending (set by the reference voltage Vref). As a result, the distance between the probe 20 and the surface of the sample 12 is held at a constant distance. Therefore, the probe 20, for example, moves (scans) following the fine profile or uneven shapes of the surface of the sample 12. By obtaining the height signal of the probe, the fine profile shapes of the surface of the sample 12 can be measured.

The scanning probe microscope as mentioned above, for example, is built into the middle of an in-line fabrication system for semiconductor devices (LSIs) as an automatic inspection process for inspecting the substrates (or wafers).

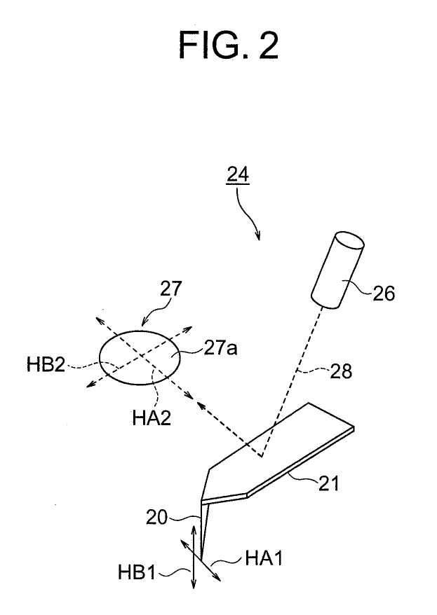

FIG. 2 is used for explaining a principle of displacement detection by the optical lever type detection device. In the above cantilever 21 the displacements thereof are generated in either or both of “HA1” and “HB1” directions based on the atomic force etc. operated upon the probe at the tip. As a result, the cantilever 21 has deformation such as bending (flexure or deflection), torsion or the like. In the cantilever displacement detection section 24, the laser light 28 emitted from the laser light source 26 is reflected at the back surface of the cantilever 21 and strikes a photodetector 27. In FIG. 2, the reference numeral 27a designates a light receiving surface of the photodetector 27. As an initial condition, the position of a spot which the laser light 28 strikes in the light receiving surface 27a of the photodetector 27 in the state with no atomic force applied to the probe 20 is memorized. Thereafter, by capturing the direction of movement of the position of the spot in the light receiving surface 27a of the photodetector 27, it is possible to accurately detect the magnitude and direction of the force acting on the probe 20 through deformation of the cantilever 21. As shown in FIG. 2, for example, when force of the HA1 direction is applied to the probe 20, the photodetector 27 catches this as a change in the spot position in the HA2 direction. Further, when force of the HB1 direction is applied to the probe 20, the photodetector 27 catches this as a change in the spot position in the HB2 direction. Here, the force in the HA1 direction is called “torsion direction force”, while the force in the HB1 direction is called “deflection direction force”.

Note that the method for detecting the atomic force etc. applied from the sample surface to the tip of the probe 20 includes, in addition to the optical lever-type photo detector, utilization of optical interference or other optical principles or a strain detection element provided at the cantilever.

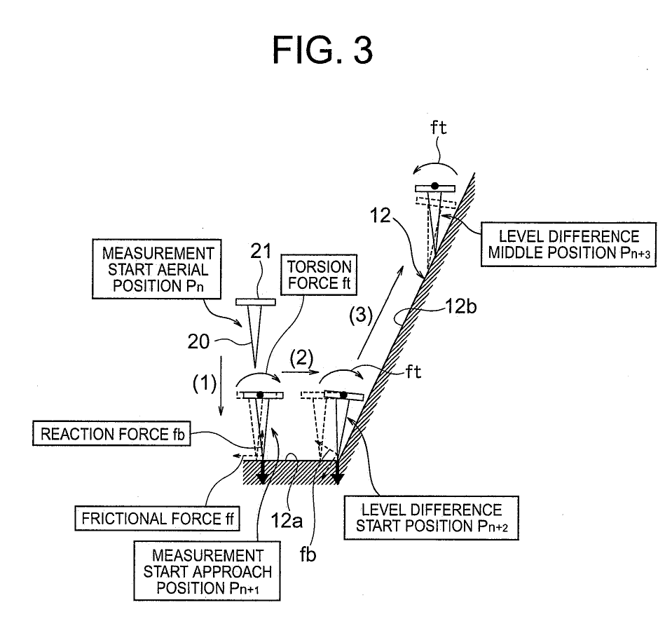

Next, a characteristic probe control method in the automatic measurement method for a scanning probe microscope will be explained with reference to FIG. 3 to FIG. 6. The probe control method is a method for controlling the position and posture of the probe when it goes up along the slope of the projected portions (or step portions) formed on the sample surface.

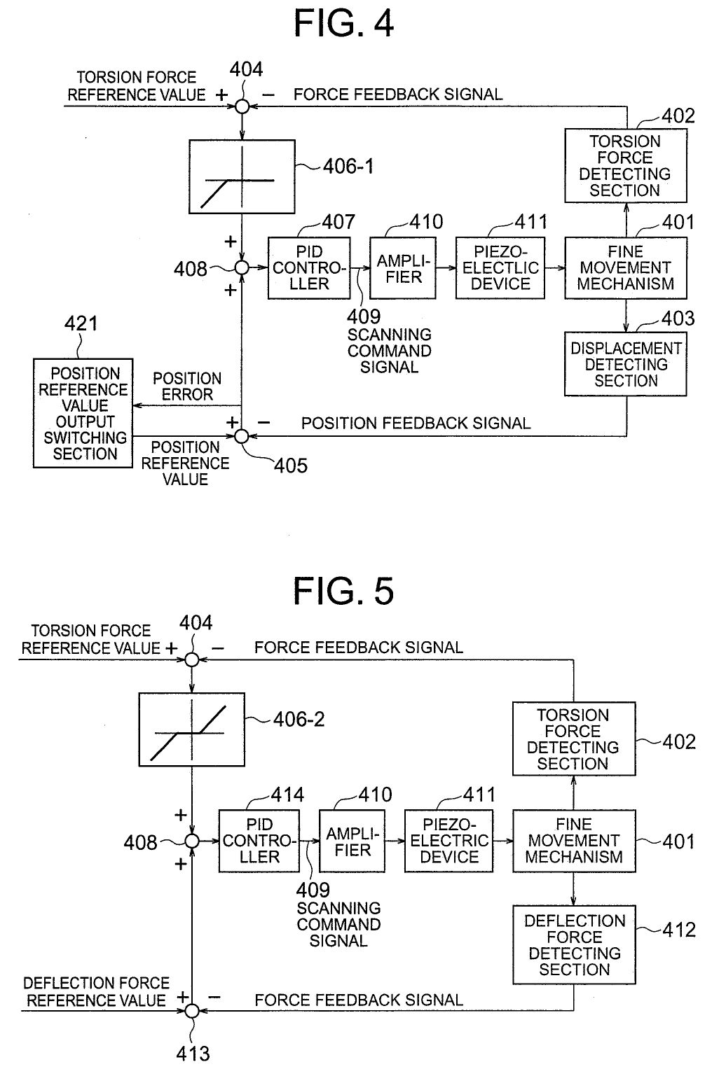

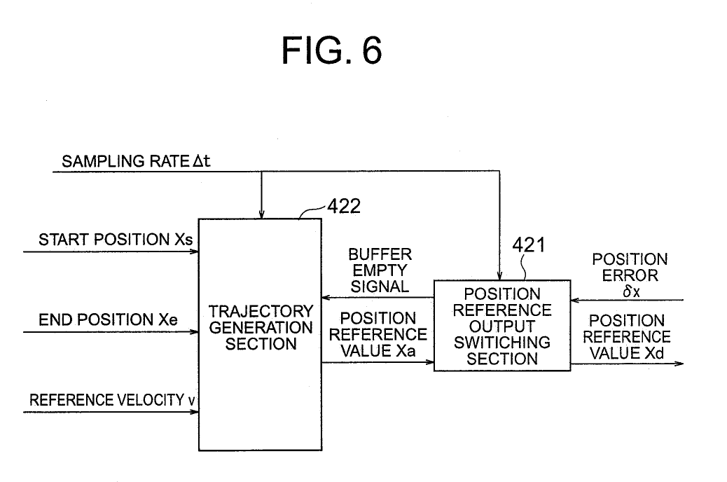

FIG. 3 shows the probe control method when the probe 20 goes up along the slope of the projected portion on the surface of the sample 12, FIG. 4 shows a control block for carrying out the control method on the scanning direction (movement direction) when controlling the scanning movement of the probe as shown in FIG. 3, FIG. 5 shows a control block for carrying out the control method on the contact direction when controlling the scanning of the probe as shown in FIG. 3, and FIG. 6 shows a control block having a function of position reference value output processing.

The probe control method explained in the present embodiment is, for example, the method of controlling the position of the probe along the upslope of the projected portion in the uneven area formed as a regular periodic uneven pattern on the surface of a wafer. Especially, it will be explained about the important method of controlling the probe position from the viewpoint of correctly measuring line edge roughness in the trenches formed on the wafer surface.

In FIG. 3, the probe 20 is seen from the pointed end side of the cantilever 21. The illustration for the surrounding structure related to the probe 20 and the cantilever 21 is omitted in FIG. 3. Moreover, the probe 20 has sufficient length required for measurement.

Moreover, in FIG. 3, it is supposed that the probe 20 is in the position (Pₙ) separated from the surface of the sample 12 in an early stage, thereafter, approaches the sample surface, and further moves from the left-hand side to right-hand side in FIG. 3 in a state of keeping it come into contact with the sample surface.

Furthermore, in FIG. 3, a level (horizontal) section 12a in the surface of the sample 12 is the flat area at the lower side of the projected portion (step section) of the sample surface. The sloping section 12b is partially shown as a lower part of the projected portion in FIG. 3.

Although an angle of the slope of the sloping section 12b is actually close to about 90 degrees, the slope shown in FIG. 3 is drawn to have a predetermined slope angle.

When the probe 20 moves to follow the surface of the sample 12, in the transitional place from the level section 12a to the sloping section 12b, the movement control method concerning the transfer (movement) direction of the probe 20 is changed by the force feedback signal under the condition that it becomes clear that the current scanning area of the probe 20 is the slope of the sloping section 12b.

That is, the probe 20 is made to approach to the sample surface and then to perform the scanning movement in touch with the sample surface when measuring a part containing the sloping section 12b in the surface of the sample 12 shown in FIG. 3. At this time, the position of the probe 20 changes with the sequence of Pₙ, Pₙ₊₁, Pₙ₊₂ and Pₙ₊₃ in accordance with the movement sequence (1)-(3) of the probe 20 shown in FIG. 3 (hereinafter it is called as movements (1)-(3)). The position Pₙ of the probe 20 is an initial position of the probe.

Next, the control procedure of movement operation of the probe 20 will be explained. FIG. 4 to FIG. 6 respectively shows a control block for realizing the control procedure, which is made by the second control device 34 as a device function.

In the control block for scanning direction control shown in FIG. 4, a fine movement mechanism 401 corresponds to the above-mentioned Y-fine actuator 30 or X-fine actuator 29 assuming that the probe 20 is moved to the Y-axis or X-axis direction. The torsion force detecting section 402 corresponds to the section including the optical lever-type photo detector. The force feedback signal outputted from the torsion force detecting section 402 is to be included in the signal s1. A displacement detecting section 403 corresponds to an X-axis displacement detector which is not shown in FIG. 4. A position feedback signal outputted from the displacement detecting section 403 is to be included in the signal s3. In accordance with this control block, a torsion force reference value is set concerning the force feedback signal and an operation part 404 calculates the difference between the force feedback signal and the torsion force reference value. Here, the torsion direction in the probe 20 and the cantilever 21 is defined to be plus (+) value, when moving the probe in the state that the probe is pressed to contact with the sample surface. Further, in accordance with this control block, a position reference value is set concerning the position feedback signal and an operation part 405 calculates the difference between the position feedback signal and the position reference value.

The position reference value given to the operation part 405 is created by the position reference value output switching section 421. The position error signal outputted from the operation part 405 is inputted into the position reference value output switching section 421.

A signal acquired by the operation part 404 is given to an adder 408 through a converter 406-1. A signal acquired by the operation part 405 is given to the adder 408 directly, or through an amplifier with a suitable gain which is not shown in the figure. The converter 406-1 carries out a process for setting a dead zone, and further a process for reducing the scanning rate when the probe is twisted heavier than the reference posture. The scanning command signal 409 outputted from the adder 408 is suitably supplied to the piezoelectric device 411 through a first PID controller 407 and an amplifier 410 to operate the fine movement mechanism 401.

In the control block for the contact direction control shown in FIG. 5, elements substantially identical to the elements explained in FIG. 4 are respectively allotted with the same reference numeral and the detailed explanations for them are omitted. Here, the contact direction is assumed to be the Z-axis direction, and in this case the fine movement mechanism 401 is the mechanism portion of the above-mentioned Z-fine actuator. The control block includes a deflection force detecting section 412. This deflection force detecting section 412 also comprises of the above-mentioned optical lever-type photo detector. The force feedback signal outputted from the deflection force detecting section 412 is a signal included in the signal s1 mentioned above. The control block has an operation part 413. The deflection force reference value is given to the operation part 43 as a reference value against to the force feedback signal outputted from the deflection force detecting section 412. The operation part 413 calculates a difference between the deflection force reference value and the force feedback signal. The difference signal outputted from the operation part 413 is inputted into the adder 408, and afterward is inputted into the amplifier 410 through a second PID controller 414. A converter 406-2 carries out the process for setting the dead zone and a process for reducing the deflection force when the probe is twisted heavier than the reference posture and increasing it when the probe is less twisted in order to keep the posture of the probe constant.

Furthermore, in regard to the control by the scanning direction control block shown in FIG. 4 and the control by contact direction control block shown in FIG. 5, either or both of them are used suitably.

Next, in accordance with FIG. 6, a process for generating the position reference value (Xd) by the position reference value output switching section 421 will be explained. This process shows an example of a method of scanning the probe with the fixed scanning rate which is obtained by reflecting the process for reducing the scanning rate of the probe by the servomechanism through the converter 406-1 in the calculation of the position reference value.

In the system shown in FIG. 6, the position reference value is generated and updated every Δt as a sampling rate. This system is comprised of the position reference value output switching section 421 and a trajectory generation section 422. The sampling rate Δt is supplied to the trajectory generation section 422 and the position reference value output switching section 421.

In the trajectory generation processing by the trajectory generation section 422, signals of a starting position (Xs), an end position (Xe) and reference velocity (v) are inputted, and a position reference value (Xa) is calculated using these input elements. A simple system, in which the increase and decrease of the velocity is not controlled, can be expressed by the following numerical formula.
Xa(n+1)=Xa(n)+vΔt

Here, Xa(n) means the position reference value at the present time, and Xa(n+1) means the following position reference value at next time. In the above-mentioned trajectory generation processing, the calculation is carried out based on the numerical formula at the timing when a buffer empty signal is inputted from the position reference value output switching section 421, and the position reference value (Xa) as the calculation result is returned to the position reference value output switching section 421. Moreover, Xa is set to be Xe when the position reference value (Xa) exceeds the end position (Xe).

Next, the position reference value output switching section 421 outputs the position reference value (Xd) in synchronizing with the signal of the sampling rate Δt. There are FIFO buffers with two or more steps in the output side of the position reference value output switching section 421, and the input value Xa is stored in the FIFO buffers. When assuming that there are the present output value Xa(n) and the next output value Xa(n+1) in the buffers, Xd is set to be Xa(n).

When judging whether the position error bx inputted has been not more than a constant value at the timing of the sampling rate Δt for the output of the position reference value (Xd) and that it has become below the constant value, the buffers are updated. That is, Xa(n) is set to be Xa(n+1).

Subsequently, the position reference value output switching section 421 outputs the position reference value (Xd). Furthermore, the position reference value output switching section 421 outputs the buffer empty signal to the trajectory generation section 422 and receives the new position reference value (Xa) outputted from it.

On the other hand, when judging that the position error (δx) has not become below the constant value at the timing of outputting the position target value (Xd), the buffers are not updated and the present data Xa(n) are outputted as it is.

By the above, if the scanning rate of the probe were to be reduced due to the feedback of the torsion signal, after that this state is cancelled, the probe 20 can be scanned at the reference velocity (v).

The movements (1)-(3) of the probe 20 shown in FIG. 3 are carried out based on the control by the scanning direction control block shown in FIG. 4, the control by the contact direction control block shown in FIG. 5, and the position reference value output processing system shown in FIG. 6.

Next, the movement of the probe 20 will be explained referring to FIG. 3.

Movement (1): The probe 20 is caused to approach the sample 12 from the measurement start aerial position Pₙ. This movement operation by which the probe 20 located at the upper spot separated from the sample surface is caused to approach so as to generate the atomic force between the probe and the sample surface is usually based on the operation of the Z-fine actuator 23. The Z-movement control section 44 of the first control device 33 generates the Z-direction movement command signal concerning approaching the sample. If the probe comes into contact with the sample surface, the deflection direction force is operated on the cantilever 21, and the reaction force fb comes to be detected. Then, the reaction force is controlled to be fixed and thereby the movement of the probe 20 is controlled to stop at the measurement start approach position Pₙ₊₁.

Next, under the condition that there is no force in the torsion direction beyond the predetermined standard value, the tip position of the probe 20 is detected by use of the Z-feedback signal indicating the amount of displacement at this time. As a result the surface position of the sample can be recorded. In this case, from the point of view of forces in both of the deflection and torsion directions, it may be taken the amount of deformation of the cantilever 21 and the probe 20 into consideration

Movement (2): Next, the probe 20 is caused to move in the scanning direction on the sample surface 12a while maintaining the state where the reaction force fb is kept to be detected. Thereby, the cantilever 21 has the torsion deformation due to frictional force ff as the probe 20 moves in the scanning direction toward the slope as shown in FIG. 3, and therefore the torsion force ft is detected.

when the probe 20 reaches the level difference start position Pₙ₊₂, the direction of the reaction force is changed by the slope 12b of the projected portion or the step on the sample surface. Thereby, the torsion force in the probe 20 and the cantilever 21 increases, and the larger torsion arises in the probe 20 and the cantilever 21.

Movement (3): The probe 20 is caused to move so that it goes up along the slope 12b of the projected portion. In this movement along the upslope 12b, the scanning rate of the probe 20 in the scanning direction is reduced in proportion to an increased amount for the torsion force of the probe 20. Thereby, in the level difference middle position Pₙ₊₃, the torsion of the probe 20 is cancelled and the posture of the probe 20 returns to its former state before generating the torsion, and further it becomes possible to perform exact measurement.

In the movement (3), instead of reducing the scanning rate of the probe 20, the deflection force as the reaction force direction applied to the probe 20 may be decreased and thereby the twisted posture as to the probe 20 and the cantilever 21 can be also cancelled. Further, it may be considered that both reduction in the scanning rate and the decrease of the deflection force in the reaction force direction are performed.

In the control concerning the movements (1)-(3), the converter 406-1 of the control block shown in FIG. 4 carries out the dead zone process to the signal outputted from the operation part 404 and thereafter returns its output signal to the feedback loop for the scanning rate. By this, like the movement (3), when the state where the probe 20 was greatly twisted in its movement occurs, the scanning rate of the probe 20 can be reduced.

Moreover, in case of the control block shown in FIG. 5, the signal outputted from the operation part 404 is returned to the feedback loop for the deflection force through the dead zone process in the converter 406-2. By this, when the probe 20 is twisted greatly, the contact force can be decreased.

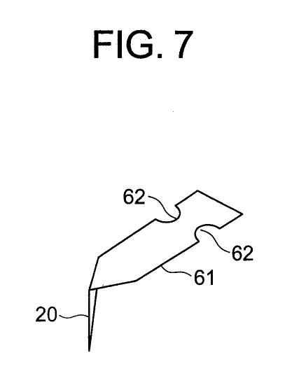

FIG. 7 shows another cantilever 61 with two notches. The two notches 62 are formed in two long sides of the cantilever 61, respectively. The notches 62 make the cantilever 61 to be easy to produce the torsion deformation. It is desirable to raise the detection sensitivity of the force in the torsion direction in the cantilever 61 in which the above structure capable of using the force of the torsion direction positively is adopted.

The configurations, shapes, sizes, and relative arrangements explained in the above embodiments are only generally shown to an extent enabling the present invention to be understood and worked. Therefore, the present invention is not limited to the embodiments explained above and can be modified in various ways so long as not departing from the scope of the technical idea shown in the claims.

The present disclosure relates to subject matter contained in Japanese Patent Application No. 2006-273929, filed on Oct. 5, 2006, the disclosure of which is expressly incorporated herein by reference in its entirety.

What is claimed is:

1. A probe control method for a scanning probe microscope having a probe section with a probe arranged so as to be pointed at a sample, a detection section for detecting physical quantity between said sample and said probe, a measurement section for measuring the surface of said sample to obtain surface information on the basis of said physical quantity when scanning said sample surface by said probe, and a movement mechanism with at least two degree of freedom, wherein said measurement section measures the surface of said sample while said movement mechanism changes the relative positional relationship between said probe and said sample by causing said probe scan the sample surface, comprising steps of;
moving said probe in a scanning direction different from a contact direction while making said probe come into contact with said sample surface,
detecting a torsional state of said probe during the movement of the probe, and
adjusting either or both of rate in said scanning direction and force in said contact direction as to said probe on the basis of a detected value obtained by said detection step.

2. A probe control method for a scanning probe microscope as set forth in claim 1, wherein adjustment of the rate in said scanning direction of said probe is performed so that torsion amount in the torsional state of said probe is canceled.

3. A probe control method for a scanning probe microscope as set forth in claim 1, wherein said scanning direction is a probe scanning direction along the surface of said sample.

4. A probe control method for a scanning probe microscope as set forth in claim 1, wherein said cantilever with said probe has notches which are easy to produce torsion.
